(19) United States
(12) Patent Application Publication
(10) Pub. No.: US 2009/0080004 A1
(43) Pub. Date: Mar. 26, 2009

(54) SYSTEM AND METHOD FOR DETERMINING AN OPTIMAL REFERENCE COLOR CHART

(75) Inventors: Xiaoling Wang, San Jose, CA (US); Farhan A. Baqai, Fremont, CA (US); Takami Mizukura, Kawasaki (JP); Naoya Katoh, Ichikawa (JP)

Correspondence Address: JOHN P. O'BANION;O'BANION & RITCHEY LLP, 400 CAPITOL MALL SUITE 1550, SACRAMENTO, CA, 95814, US

(73) Assignees: SONY CORPORATION, Tokyo (JP); SONY ELECTRONICS, INC., Park Ridge, NJ (US)

(21) Appl. No.: 11/862,107

(22) Filed: Sep. 26, 2007

(51) Int. Cl. H04N 1/60

(52) U.S. Cl. 358/1.9

(57) ABSTRACT

A color chart for color calibration of imaging devices that has nearly identical calibration performance as the Macbeth ColorChecker or another set of reference colors, but with substantially fewer color patches. For example, the color chart has similar 2nd order statistical characteristics, auto-correlation matrix and major principal components as the Macbeth ColorChecker. The color chart is developed by applying Orthogonal Non-negative Matrix Factorization (ONMF) to the set of reference colors, using non-negativity and smoothness constraints to achieve physically realizable colors and using orthogonality constraints to obtain similar statistical properties to that of any input set of reflectances including, but not limited to, the Macbeth ColorChecker. Seven colors provide nearly identical calibration performance to that of twenty-four colors in the Macbeth ColorChecker.

### CROSS-REFERENCE TO RELATED APPLICATIONS

Not Applicable

### STATEMENT REGARDING FEDERALLY SPONSORED RESEARCH OR DEVELOPMENT

Not Applicable

### INCORPORATION-BY-REFERENCE OF MATERIAL SUBMITTED ON A COMPACT DISC

Not Applicable

### NOTICE OF MATERIAL SUBJECT TO COPYRIGHT PROTECTION

A portion of the material in this patent document is subject to copyright protection under the copyright laws of the United States and of other countries. The owner of the copyright rights has no objection to the facsimile reproduction by anyone of the patent document or the patent disclosure, as it appears in the United States Patent and Trademark Office publicly available file or records, but otherwise reserves all copyright rights whatsoever. The copyright owner does not hereby waive any of its rights to have this patent document maintained in secrecy, including without limitation its rights pursuant to 37 C.F.R. § 1.14.

### BACKGROUND OF THE INVENTION

1. Field of the Invention

This invention pertains generally to color calibration in digital cameras, and more particularly to orthogonal non-negative matrix factorization.

2. Description of Related Art

Color calibration in a digital imaging device, such as a digital camera, involves determination of a linear adjustment matrix (AM) to match the XYZ/L*a*b* values calculated from a real camera to those of the human visual system. A typical calibration process is illustrated in FIG. 1. The input parameters are camera spectral sensitivities of different color channels, spectral intensity of the illuminant, and spectral reflectance of a set of color patches as the calibration target. The adjustment matrix depends on the input parameters and the optimization method used for its estimation.

For higher-end cameras, the Macbeth ColorChecker with twenty-four patches is used for calibration because of its good representation of the entire color spectrum. For example, S. Quan, in “Evaluation And Optimal Design Of Spectral Sensitivities For Digital Color Imaging,” Ph.D. Dissertation, Chester F. Carlson Center for Imaging Science of the College of Science, Rochester Institute of Technology, April, 2002, incorporated herein by reference in its entirety, confirmed that the Macbeth ColorChecker has very similar principal components (PCs) compared to the Vrhel-Trussell color set. In addition, the reconstruction error from these sets of PCs is negligible.

FIG. 2 and FIG. 3A through FIG. 3C show comparisons of the first three PCs and auto-correlation matrices among three standard color sets used in color imaging science, including: (i) the Vrhel-Trussell set (see, M. J. Vrhel, R. Gershon and L. S. Iwan, “Measurement And Analysis Of Object Reflectance Spectra,” Color Research and Application, 19, 4-9, 1994, incorporated herein by reference in its entirety), (ii) the SOCS set (see, J. Tajima, “Development And Analysis Of Standard Object Color Spectral Database (SOCS),” Proceedings of International Symposium on Multispectral Imaging and color Reproduction for Digital Archives, 16-33, 1999, incorporated herein by reference in its entirety), and (iii) the Macbeth ColorChecker. Note that the SOCS set has 11539 color patches and the Vrhel-Trussell set has 354 color patches. On the other hand, the Macbeth ColorChecker with only 24 patches, shows very similar spectral characteristics with significantly fewer color patches compared to the other two sets. Yet, the number of color patches in Macbeth ColorChecker is still too large to be implemented on the factory floor and it makes calibration complicated and time-consuming.

Data reduction methods are known techniques for reducing the dimension of a data set, and use, for example, appropriate basis functions of lower dimension to represent the original data set. The most widely used data reduction methods include Principal Component Analysis (PCA) and Independent Component Analysis (ICA).

The basis functions obtained by PCA are orthogonal and correspond to the directions of maximal variance in a Gaussian space. In other words, PCA reduces the 2^{nd} order statistics of the original set. Alternatively, ICA reduces higher order statistics of the data set and seeks basis functions that give rise to maximal statistical independence in non-Gaussian space. FIG. 4A and FIG. 4B show two examples of basis functions obtained by PCA and ICA respectively.

A common feature of PCA and ICA basis functions is that they are composed of both positive and negative values. In many applications, negative components contradict physical realities. For example, an image with negative intensities cannot be reasonably interpreted and negative color reflectance does not have any physical meaning. Therefore, color filters in digital cameras, copiers, and scanners should have non-negative components. While PCA/ICA basis vectors can be used to create color patches, the challenge with this approach is to find a set of weights that will combine PCA/ICA basis vectors to generate an optimal set of color patches. With non-negativity constraints, the basis vectors themselves represent optimal colors.

A technique referred to as “non-negative matrix factorization”, or NMF, can be used for determining a small set of color patches. As the name implies, NMF tries to find basis functions and coefficients that are always non-negative. A non-negative NMF approach for determining a small set of color patches for calibration and color filter array design was previously described in F. Baqai, “Identifying Optimal Colors For Calibration And Color Filter Array Design,” U.S. patent application Ser. No. 11/395,120 filed on Mar. 31, 2006, incorporated herein by reference in its entirety. Note that only additive combinations are allowed in the factorization process. The problem can be formularized as: given a non-negative matrix V, find non-negative factors W and H to best approximate V, i.e.,

V_{n×n}≈W_{n×r}·H_{r×m}

where W≧0, H≧0, r<m, n. In the computation of the reflectance set, m, n-dimensional reflectance (e.g., the Macbeth ColorChecker) is combined into matrix V. Then after factorization, matrix H contains the non-negative weights and W contains the non-negative basis functions that can be considered directly as the set of reflectance with reduced dimension.

In other words, the objective of NMF is to find the best approximation of the original data matrix V by only additive contributions of non-negative basis vectors. For example, V can be the set of reflectance R, and W contains the non-negative basis vectors, and H contains the weights where H≧0.

There are several different cost functions and update rules described in the literature for NMF problem. The simplest one is derived based on the minimization of Kullback-Leibler divergence between V and W·H. The update rules are:

$${W}_{ia} ← {W}_{ia} {\sum }_{μ} \frac{{V}_{i μ}}{{( WH )}_{i μ}} {H}_{a μ}$$

$${W}_{ia} ← \frac{{W}_{ia}}{{\sum }_{j} {W}_{ja}}$$

$${H}_{a μ} ← {H}_{a μ} {\sum }_{i} {W}_{ia} \frac{{V}_{i μ}}{{( WH )}_{i μ}}$$

In NMF, the basis functions and coefficients are always non-negative; only additive combinations are allowed. Other than non-negativity, the basis functions obtained by NMF have the following properties as described by G. Buchsbaum and O. Bloch, “Color Categories Revealed By Non-Negative Matrix Factorization Of Munsell Color Spectra”, Vision Research, Vol. 42, pp. 559-563, 2002, incorporated herein by reference in its entirety:

1. Unless non-overlapping, basis functions are non-orthogonal.

2. Basis functions are local and have no zero crossing.

3. Basis functions correspond to physical or conceptual features in non-negative space.

4. Basis functions vary according to the number computed.

5. Implementation requires iterative optimization.

Additional background information relating to NMF can be found in D. D. Lee and H. S. Seung, “Learning The Parts Of Objects By Non-Negative Matrix Factorization,” Nature, vol. 401, pp. 788-791, October, 1999; D. D. Lee and H. S. Seung, “Algorithms For Non-Negative Matrix Factorization,” Advances in Neural and Information Processing Systems, vol. 13, pp. 556-562, 2001; and C. Ding, T. Li, W. Peng and H. Park, “Orthogonal Nonnegative Matrix Tri-Factorizations For Clustering,” Proceedings of International Conference on Knowledge Discovery and Data Mining, pp. 126-135, August, 2006, each of which is incorporated herein by reference in its entirety.

### BRIEF SUMMARY OF THE INVENTION

Accordingly, an aspect of the invention is a color chart for color calibration of imaging devices that comprises a set of spectral reflectance. In one embodiment, the reflectance set has similar 2nd order statistical characteristics as the Macbeth ColorChecker. In one embodiment, the reflectance set has similar auto-correlation matrix and major principal components as the Macbeth ColorChecker.

Another aspect of the invention is a method for determining optimal color target based on Orthogonal Non-negative Matrix Factorization (ONMF). In one embodiment, the statistical characteristics of the Macbeth ColorChecker are kept in the resultant ONMF color target.

Another aspect of the invention is a system and method that retains similar properties as that of the Macbeth ColorChecker with substantially fewer color patches.

Another aspect of the invention is a method for obtaining an optimal color chart. In one embodiment, non-negativity and smoothness constraints are incorporated to achieve physically realizable colors and orthogonality constraints are used to obtain similar statistical properties to that of any input set of reflectances including, but not limited to, the Macbeth ColorChecker.

Another aspect of the invention is an optimal color chart that provides nearly identical calibration performance to that of the Macbeth ColorChecker. In one embodiment, 7 colors provide nearly identical calibration performance to that of 24 colors in the Macbeth ColorChecker. In other embodiments, any number of colors greater than 5 and less than 24 are used in the reference color chart.

Another aspect of the invention is a process for estimating a minimal set of optimal reference colors, from a larger color set, that can be used for accurate reproduction of colors in any system such as photography both still and video, graphic arts, electronic publishing, hardcopy (printers) and softcopy (television, monitor, etc) systems.

Another aspect of the invention is a method for selecting any similar reference color set, according to any of the foregoing aspects, which is within manufacturer tolerances of the optimal color chart while maintaining reasonable color calibration accuracy.

Further aspects of the invention will be brought out in the following portions of the specification, wherein the detailed description is for the purpose of fully disclosing preferred embodiments of the invention without placing limitations thereon.

### BRIEF DESCRIPTION OF THE SEVERAL VIEWS OF THE DRAWING(S)

The invention will be more fully understood by reference to the following drawings which are for illustrative purposes only:

FIG. 1 is a flow diagram illustrating a typical process used for calibrating digital cameras.

FIG. 2 is a comparison of the first three principal components (PCs) used in three standard color sets used in color imaging.

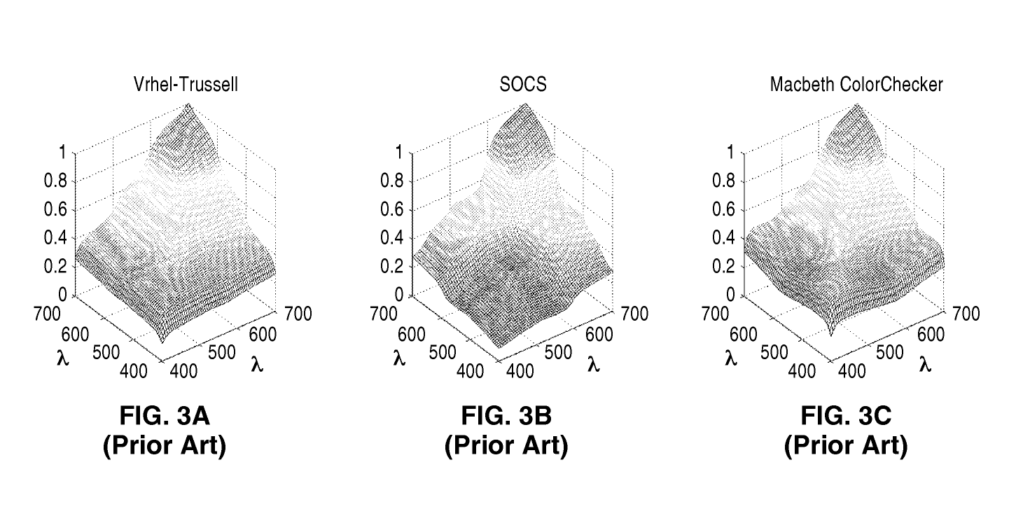

FIG. 3A through FIG. 3C are plots comparing the auto-correlation matrices used in three standard color sets used in color imaging.

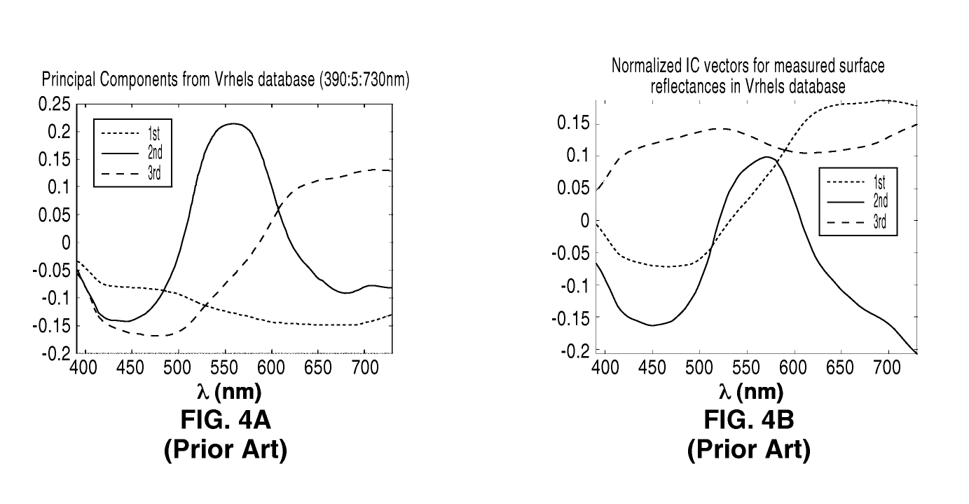

FIG. 4A and FIG. 4B are graphs illustrating example basis functions obtained by Principal Component Analysis (PCA) (FIG. 4A) and Independent Component Analysis (ICA) (FIG. 4B).

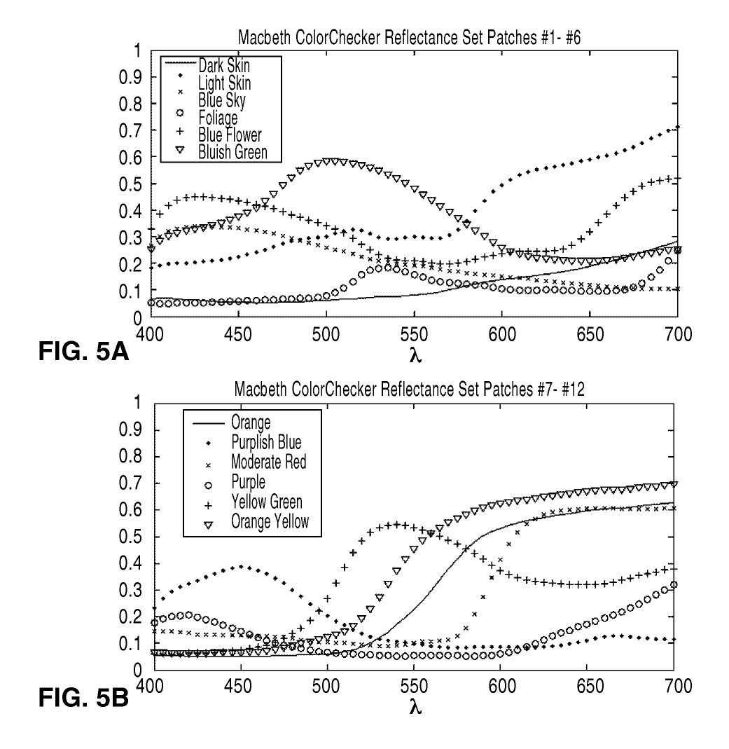

FIG. 5A through FIG. 5D are graphs illustrating the measured spectral reflectance of the twenty-four Macbeth ColorChecker color patches where FIG. 5A shows patches #1-#6; FIG. 5B shows patches #7-#12; FIG. 5C shows patches #13-#18; and FIG. 5D shows patches #19-#24.

FIG. 6A and FIG. 6B are graphs illustrating error measurements for varying number of color patches from 3 to 15 in an embodiment of orthogonal non-negative matrix factorization (ONMF) according to the present invention where FIG. 6A shows average absolute error and FIG. 6B shows mean-square-error.

FIG. 7 illustrates the spectral reflectance of an optimal set of color patches obtained by an embodiment of orthogonal non-negative matrix factorization (ONMF) according to the present invention. The number of color patches in this optimal set is fixed to r=7.

FIG. 8 illustrates the spectral reflectance of an optimal set of color patches obtained by an embodiment of orthogonal non-negative matrix factorization (ONMF) according to the present invention. The number of color patches in this optimal set is fixed to r=5.

FIG. 9 illustrates the spectral reflectance of an optimal set of color patches obtained by an embodiment of orthogonal non-negative matrix factorization (ONMF) according to the present invention. The number of color patches in this optimal set is fixed to r=6.

FIG. 10 illustrates the spectral reflectance of an optimal set of color patches obtained by an embodiment of orthogonal non-negative matrix factorization (ONMF) according to the present invention. The number of color patches in this optimal set is fixed to r=8.

FIG. 11 illustrates the spectral reflectance of an optimal set of color patches obtained by an embodiment of orthogonal non-negative matrix factorization (ONMF) according to the present invention. The number of color patches in this optimal set is fixed to r=9.

FIG. 12A and FIG. 12B are plots comparing auto-correlation between the Macbeth ColorChecker (FIG. 12A) and the optimal set calculated by an embodiment of orthogonal non-negative matrix factorization (ONMF) according to the present invention (FIG. 12B) when r=7.

FIG. 13A and FIG. 13B are graphs comparing the first six principal components of the Macbeth ColorChecker and the optimal set calculated by an embodiment of orthogonal non-negative matrix factorization (ONMF) according to the present invention when r=7. The first three principal components are shown in FIG. 13A and the second three principal components are shown in FIG. 13B.

### DETAILED DESCRIPTION OF THE INVENTION

1. Introduction.

In the present invention we obtain a smaller set of color patches that has, for example, similar calibration performance as the Macbeth ColorChecker which is considered by the industry to be an “optimal” set of color patches. In one non-limiting embodiment, we add an orthogonality constraint to the weight matrix in the NMF algorithm to determine the smaller optimal set of color patches. Therefore, we refer to our new method for determining the smaller optimal set of color patches as “Orthogonal” NMF, or ONMF.

We have successfully demonstrated that, by using this smaller optimal color set, we can achieve the calibration accuracy of the Macbeth ColorChecker at a much lower computational cost. It will be appreciated, however, that the present invention is not only applicable to the Macbeth ColorChecker set of color patches but can be applied to any arbitrary reflectance set to obtain an optimal, spectrally equivalent, set of colors. Furthermore the derived ONMF optimal color set is robust to small variations in spectral magnitude and wavelength shift which accommodates the essential errors introduced in chart manufacturing. Therefore, any version of the ONMF optimal set with slight difference in either spectral magnitude or wavelength shift is considered to be within the scope of the present invention.

2. Orthogonal Non-Negative Matrix Factorization (ONMF)

In contrast to NMF, in ONMF we add an orthogonality constraint to the weight matrix in the NMF approach. We have verified that, by adding this constraint, second-order properties of the minimally optimal set of color patches are nearly identical to the second-order properties of the input color set.

(a) Application of Orthogonality and Smoothness Constraints

In one embodiment of the invention for DSC color calibration, our goal is to find an optimal set of color patches that has similar statistical characteristics as the Macbeth ColorChecker. We use the auto-correlation matrix (second order statistics) of a reflectance set as a measure of similarity.

To this end, we introduce a constraint into NMF so that the original data matrix V and the factorized matrix W have approximately the same auto-correlation relationship. By introducing an orthogonality constraining into the original NMF formulation, the auto-correlation matrix of W (rank r) equals the auto-correlation matrix of V (rank m) where r<m.

This corresponds to an orthogonality constraint on the weight matrix H in the original NMF formulation, i.e.,

if HH^{T}=I, then

VV^{T}≈WH(WH)^{T}=WHH^{T}W^{T}=WIW^{T}=WW^{T}.

In this sense, the reduced set W_{n×r} has similar second-order properties as the original set V_{n×m} where r<m. In color calibration, this is equivalent to

R_{Macbeth}R_{Macbeth}^{T}=Kr_{Macbeth}≈Kr_{Optimal}=R_{Optimal}R_{Optimal}^{T}

In order for the factorized matrix W to be considered directly as a set of color reflectance, its column vectors should be continuous and smooth in order to represent real colors. Therefore, we add an additional smoothness constraint into the NMF formulation. Additionally, in order to make sure that the scales of the original set V and the reduced set W are the same, we constrain the column summation of weight matrix H to equal 1 (see, for example, B. Bodvarsson, L. K. Hansen, C. Svarer, and G. Knudsen, “NMF On Positron Emission Tomography”, Proceedings of IEEE Conference on Acoustics, Speech, and Signal Processing, pp. I-309-I-312, April 2007, incorporated herein by reference in its entirety).

In summary, the ONMF problem is defined as follows:

V_{n×m}≈W_{n×r}·H_{r×m}
where W≧0, H≧0

HH^{T}=I
sum(each column of H)=1
column vectors of W are continuous and smooth
   Note also that the orthogonality constraint of H is an approximation resulting from numerical optimization.

(b) Update Rules of ONMF

As in the NMF algorithm, the basis functions of ONMF are also calculated through iterative optimization. Multiplicative update rules are employed with additional operators to accommodate the orthogonality and smoothness constraints. The update rules of W and H are as follows:

$${W}_{ia} ← {W}_{ia} \frac{{( {VH}^{T} )}_{ia}}{{( {WHH}^{T} )}_{ia} + α {W}_{ia}}$$

$${H}_{a μ} ← {H}_{a μ} \sqrt{\frac{{( {W}^{T} V )}_{a μ}}{{( {W}^{T} {VH}^{T} H )}_{a μ} + β {H}_{a μ}}}$$

$${H}_{a μ} ← \frac{{H}_{a μ}}{{\sum }_{j} {H}_{j μ}}$$

where α and β are sufficiently small constants (e.g. α=β=1e−4 in our experiments). The square root operator in the H_{a μ} update rule ensures the row orthogonality of weight matrix H, while the two terms αWᵢₐ and βH_{aμ} contribute to the smoothness constraint; i.e., to eliminate sharp changes and breaking points in the basis reflectance vectors.

### EXAMPLE

### Use of ONMF in DSC Color Calibration

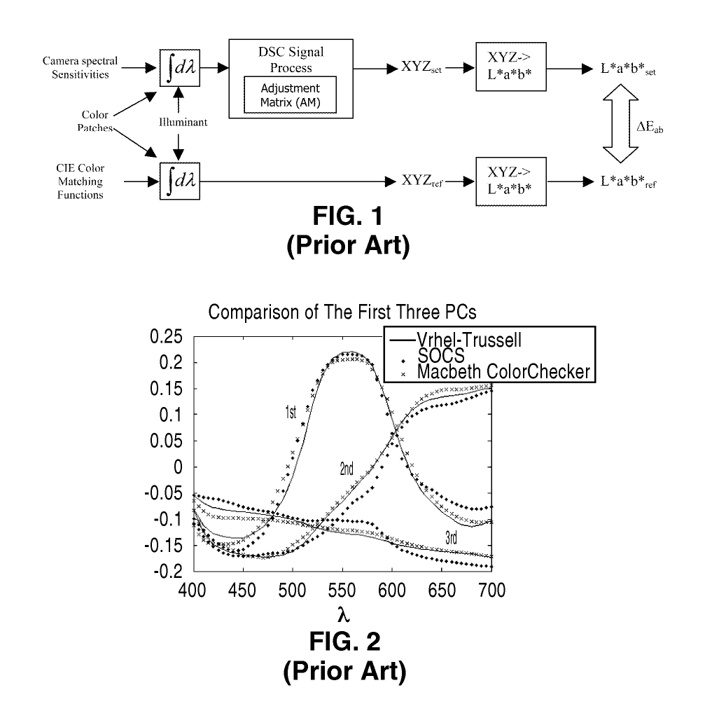

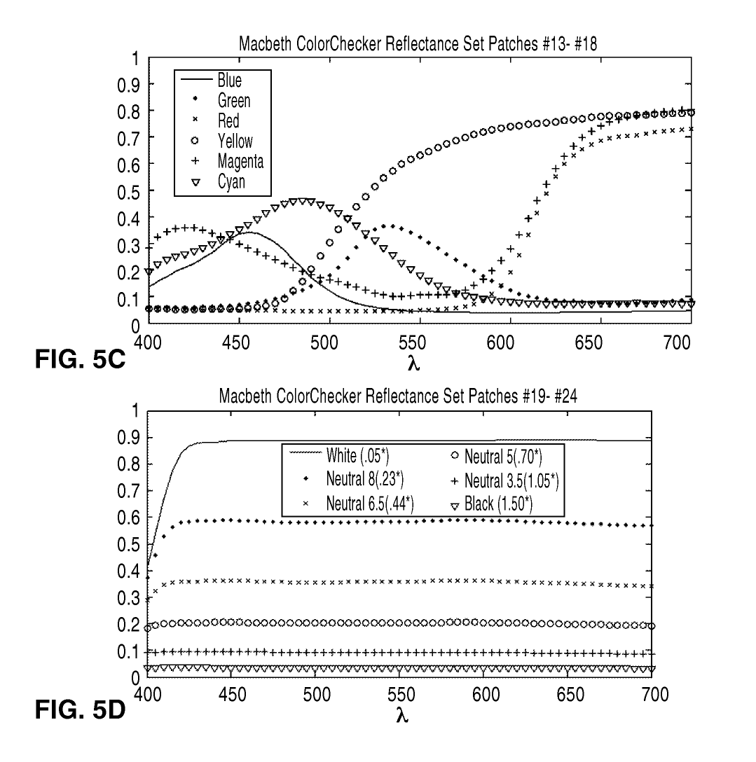

The DSC signal processing pipeline employed in our experiments is illustrated in FIG. 1. The calibration task was to optimize the adjustment matrix (AM) such that color error in L*a*b* space (ΔE_{ab}) is minimized. We denote the sensors' spectral sensitivities as S, the color matching functions of human visual system (HVS) as A, and the illuminant as 1, then

$$A = [ \begin{matrix}{x}_{1} & {y}_{1} & {z}_{1} \\ {x}_{2} & {y}_{2} & {z}_{2} \\ ⋮ & ⋮ & ⋮ \\ {x}_{n} & {y}_{n} & {z}_{n}\end{matrix} ] , \\ S = [ \begin{matrix}{r}_{1} & {g}_{1} & {b}_{1} \\ {r}_{2} & {g}_{2} & {b}_{2} \\ ⋮ & ⋮ & ⋮ \\ {r}_{n} & {g}_{n} & {b}_{n}\end{matrix} ] , \\ L = diag ( 1 ) = ( \begin{matrix}{l}_{1} & 0 & ⋯ & 0 \\ 0 & {l}_{2} & ⋯ & 0 \\ ⋮ & ⋮ & ⋰ & ⋮ \\ 0 & 0 & ⋯ & {l}_{n}\end{matrix} )$$

where n is the number of the discrete spectra data. The spectral reflectance of a given color set (Macbeth ColorChecker in our experiments) is denoted as R

$$R = [ \begin{matrix}{R}_{1 , 1} & {R}_{1 , 2} & ⋯ & {R}_{1 , m} \\ {R}_{2 , 1} & {R}_{2 , 2} & ⋯ & {R}_{2 , m} \\ ⋮ & ⋮ & ⋰ & ⋮ \\ {R}_{n , 1} & {R}_{n , 2} & ⋯ & {R}_{n , m}\end{matrix} ]$$

where m is the number of color patches. The measured spectral reflectance of the Macbeth ColorChecker twenty-four patches are illustrated in FIG. 5A through FIG. 5D and their corresponding calorimetric values under D65 are shown in Table 1.

Raw RGB output of the camera was calculated as

$$\begin{matrix}{S}_{LR} = ( \begin{matrix}{R}_{1} & {R}_{2} & ⋯ & {R}_{m} \\ {G}_{1} & {G}_{2} & ⋯ & {G}_{m} \\ {B}_{1} & {B}_{2} & ⋯ & {B}_{m}\end{matrix} ) \\ = {S}_{L}^{T} \cdot R = {( L \cdot S )}^{T} \cdot R \\ = {S}^{T} \cdot L \cdot R\end{matrix}$$

Reference XYZ of HVS was calculated as

$$\begin{matrix}{A}_{LR} = ( \begin{matrix}{X}_{1} & {X}_{2} & ⋯ & {X}_{m} \\ {Y}_{1} & {Y}_{2} & ⋯ & {Y}_{m} \\ {Z}_{1} & {Z}_{2} & ⋯ & {Z}_{m}\end{matrix} ) \\ = {A}_{L}^{T} \cdot R = {( L \cdot A )}^{T} \cdot R \\ = {A}^{T} \cdot L \cdot R\end{matrix}$$

Least square error optimization was used to match S_{LR} to A_{LR}, and the adjustment matrix AM_{L-S} was determined as follows:

AM_{L-S}·S_{LR}=A_{LR}

AM_{L-S}=(A_{LR}·S_{LR}^{T})·(S_{LR}·S_{LR}^{T})⁻¹=(A_{L}^{T}·R·R^{T}·S_{L})·(S_{L}^{T}·R·R^{T}·S_{L})⁻¹

In this simplest case, given sensor spectral sensitivities and illuminant, the values of adjustment matrix AM_{L-S} only depend on the auto-correlation matrix of spectral reflectance set Kᵣ=R·R^{T}. This is exactly in accordance with the principle of ONMF that the factorized set W has approximately same auto-correlation matrix as the original set V. Therefore, we can readily apply ONMF to decide the optimal calibration set by taking the spectral reflectance set of Macbeth ColorChecker as matrix V. Then, the resultant matrix W contains the spectral reflectance of the optimal color set with less number of patches.

Since the calculated basis functions in W vary according to the specified number of patches, we applied ONMF multiple times with different number of color patches (i.e., different number of columns in W). The least-square calibration results were compared to those using the Macbeth ColorChecker as a calibration standard and the differences were measured by two error metrics: average absolute error of AM_{L-S} and mean-square-error of AM_{L-S}:

$$Average absolute error \text{:} \frac{1}{9} \sum \vert {AM}_{L - S ( Macbeth )} - {AM}_{L - S ( Optimal )} \vert$$

$$Mean \text{-} square error \text{:} \sqrt{\frac{1}{9} \sum {( {AM}_{L - S ( Macbeth )} - {AM}_{L - S ( Optimal )} )}^{2}}$$

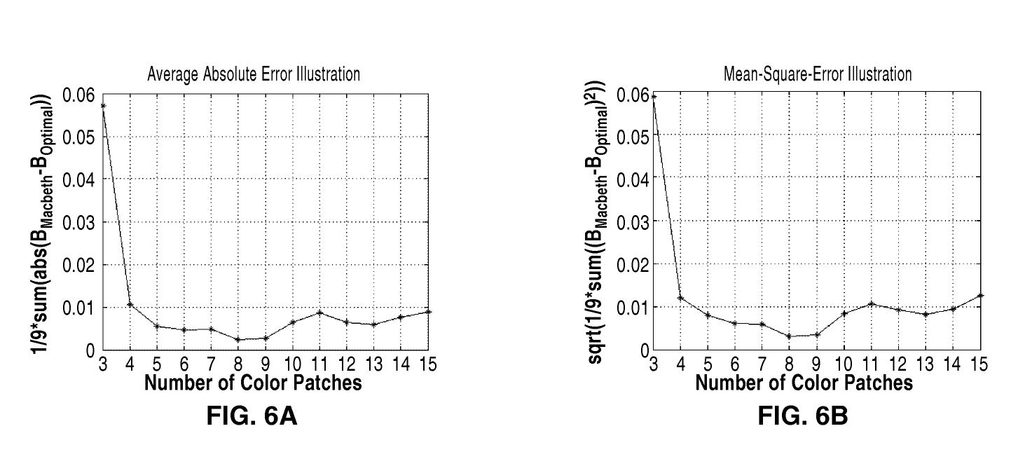

The error measurements for varying number of color patches from 3 to 15 in ONMF are illustrated in FIG. 6A and FIG. 6B. We can see that the two error metrics have similar behavior and, when the number of patches is greater than 5, both error metrics become stable. In this non-limiting example, we selected matrix W_{n×r} with r=7 to illustrate the performance of ONMF in approximating the reflectance set of the Macbeth ColorChecker. It will be appreciated that this is but one embodiment of the invention, and that use of a different number of patches (e.g., various r values) less than the number of patches used in Macbeth ColorChecker is also within the scope of the present invention. For example, 5, 7, 8, or 9 patches also provide excellent results. Essentially as few as 4 patches could be used with acceptable results, and the upper end of the range is limited only by a loss of reduced complexity that would result from using a set of color patches that is not substantially smaller than the Macbeth ColorChecker.

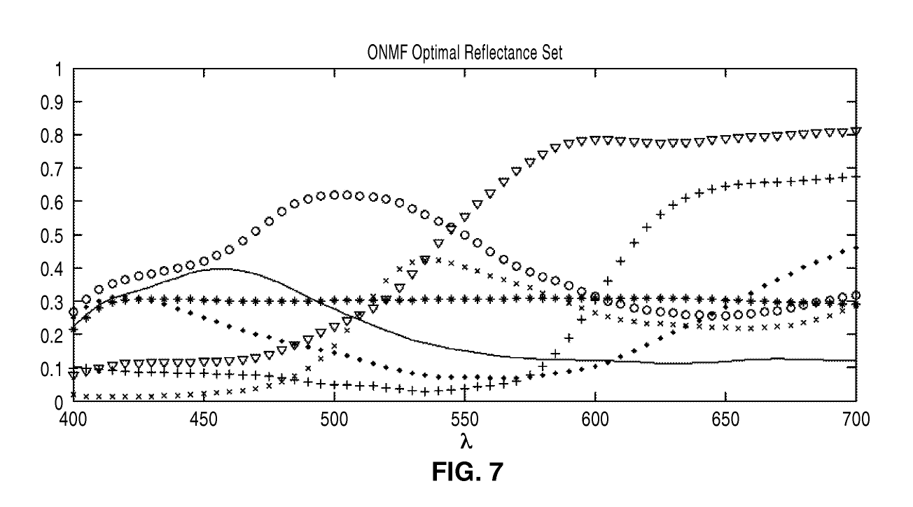

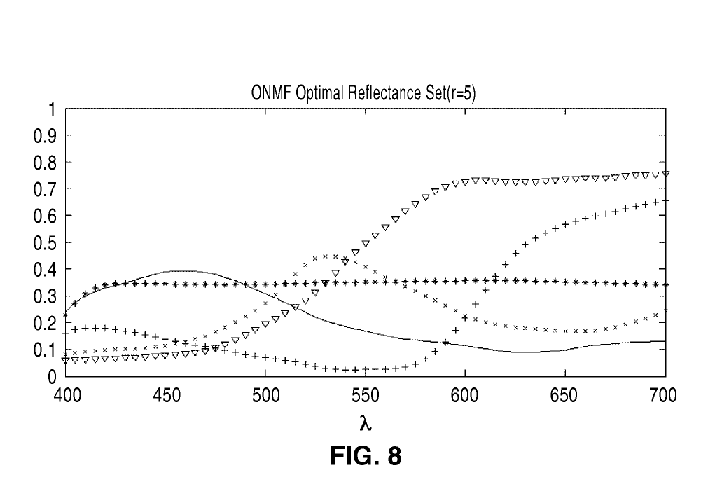

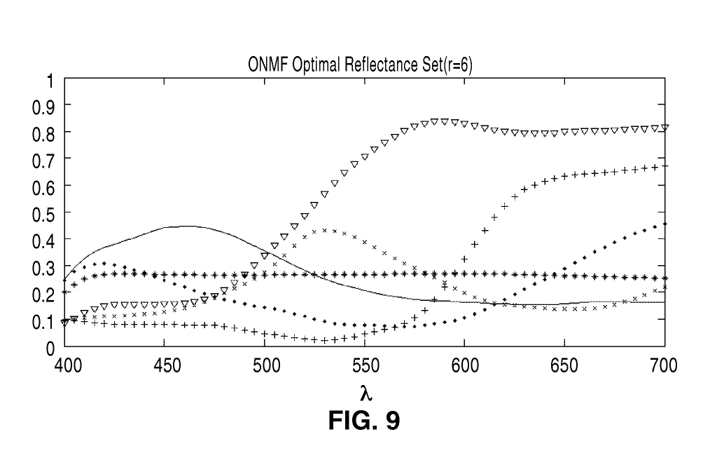

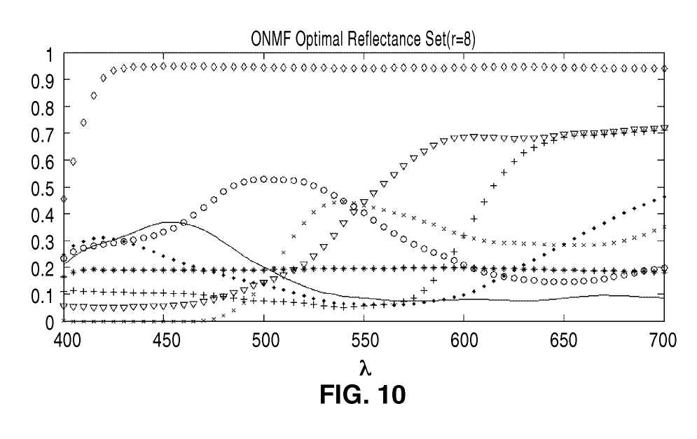

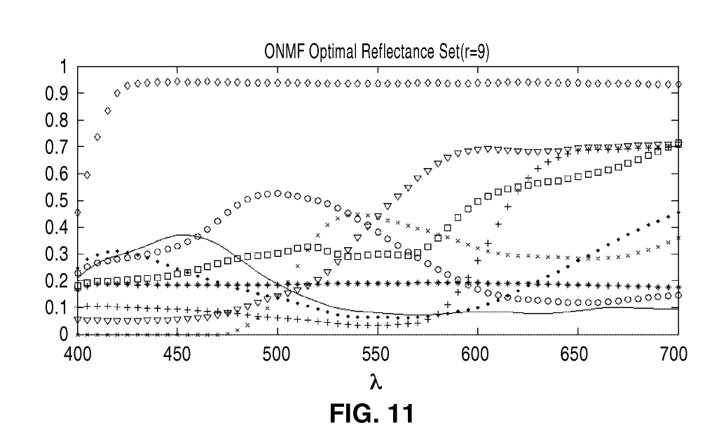

When applying ONMF on the reflectance set of the Macbeth ColorChecker with r=7, the resultant optimal set W_{n×r} is composed of six color patches and one grey patch. The spectral reflectance of the generated optimal set and their corresponding calorimetric values are shown in FIG. 7 and Table 2. The spectral reflectance of the optimal color set generated by ONMF when r is set to 5, 6, 8, and 9 are presented in FIG. 8 through FIG. 11, respectively, and their corresponding calorimetric values are shown in Table 3 through Table 6, respectively. For generality and ease of manufacturing, the grey patch can be substituted by any existent grey patches as in the Macbeth ColorChecker.

Note that one non-limiting aspect of the invention is a color set that has similar calorimetric data (within manufacturer tolerances) to the calorimetric values outlined in Table 2 through Table 6 for illuminant D65. The particular illuminant illustrated is only an example, however, and colorimetric data can be generated for other illuminants as well. Another non-limiting aspect of the invention is a color set whose spectral sensitivities (within manufacturer tolerances) correspond to the colorimetric values outlined in Table 2 through Table 6.

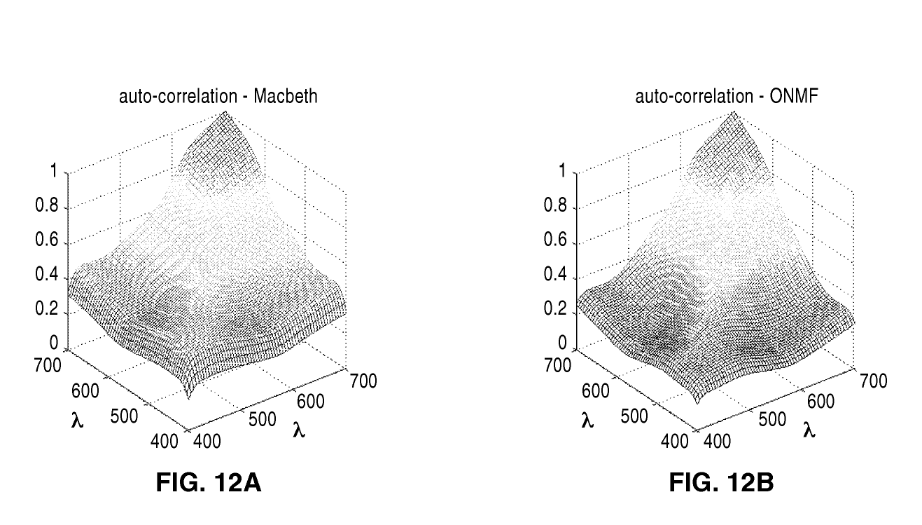

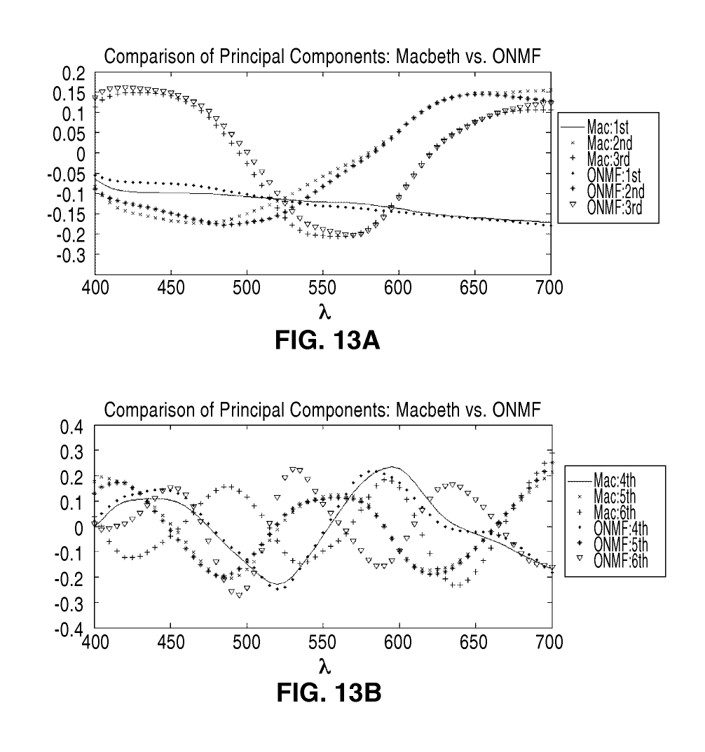

Note that ONMF according to the present invention preserves the second-order statistics of the original data set. This property is important in DSC color calibration since the adjustment matrix AM is only affected by the auto-correlation matrix of the target color set in a given calibration situation. FIG. 12A and FIG. 12B compare the auto-correlation matrix of Macbeth ColorChecker (FIG. 12A) and that of the optimal set calculated by ONMF (FIG. 12B). It is clear that the two auto-correlation matrices are very similar to each other, which verifies the effectiveness of ONMF in calibration. Another interesting feature of a reflectance set is the distribution of PCs which are orthogonal basis to linearly represent the original color set. FIG. 13A and FIG. 13B plot the first six principal components of both Macbeth ColorChecker and the optimal set calculated by ONMF. It can be seen that the PCs of the two data sets are very similar, especially the first five PCs that represent most of the energy in the two data sets. This proves that the optimal set obtained by ONMF keeps most significant features of the Macbeth ColorChecker.

Finally, the calibration performance of the Macbeth ColorChecker and the ONMF optimal set was evaluated in DSC signal processing pipeline as shown in FIG. 1. We choose the Macbeth ColorChecker as the evaluation target. The adjustment matrix AM was optimized using gradient descent method with initial value calculated as AM_{L-S}, and then the resultant color errors in L*a*b* space (ΔE_{ab}) were calculated for both color sets and shown in Table 7. It is clear that the ONMF optimal set preserves the physical property of the Macbeth ColorChecker by achieving similar color errors in real camera signal processing pipeline.

Since the ONMF algorithm solves a factorization problem where the magnitude variations in the basis vector set W can be easily compensated by changing the scales of weight matrix H, the resultant ONMF optimal set is robust to small magnitude changes. Therefore, any similar reference color set within manufacturer tolerances is able to maintain reasonable color calibration accuracy and is considered a derivative of the claimed invention. Additionally, this feature of ONMF provides a convenient tool that the magnitude of any color patch in the optimal reflectance set can be changed manually to meet user-defined requirements without affecting calibration performance significantly.

It will be appreciated that the ONMF approach is able to generate a very good approximation of Macbeth ColorChecker in the sense of both statistical properties (such as auto-correlation matrix and principal components) and DSC color calibration performance. However, the optimal set calculated by ONMF reduces the number of required color patches significantly. Utilizing these optimal set of color patches, similar calibration performance can be achieved compared to the Macbeth ColorChecker. This implies increased throughput and faster manufacturing time. In addition to applications in color calibration, the ONMF approach can also be employed in a wide range of color imaging applications, including but not limited to illuminant estimation and chromatic adaptation.

Although the description above contains many details, these should not be construed as limiting the scope of the invention but as merely providing illustrations of some of the presently preferred embodiments of this invention. Therefore, it will be appreciated that the scope of the present invention fully encompasses other embodiments which may become obvious to those skilled in the art, and that the scope of the present invention is accordingly to be limited by nothing other than the appended claims, in which reference to an element in the singular is not intended to mean “one and only one” unless explicitly so stated, but rather “one or more.” All structural, chemical, and functional equivalents to the elements of the above-described preferred embodiment that are known to those of ordinary skill in the art are expressly incorporated herein by reference and are intended to be encompassed by the present claims. Moreover, it is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. 112, sixth paragraph, unless the element is expressly recited using the phrase “means for.”

TABLE 1
Colorimetric Data of Macbeth ColorChecker

| | | CIEXYZ | | | CIE L*a*b* | | | Munsell Notation | |
|---|---|---|---|---|---|---|---|---|---|
| No. | Number | X | Y | Z | L* | a* | b* | Hue Value/Chroma | |
| 1 | dark skin | 11.29 | 9.70 | 6.56 | 37.290 | 13.543 | 15.584 | 2.7 YR | 3.63/3.57 |
| 2 | light skin | 39.27 | 35.57 | 28.11 | 66.190 | 14.313 | 17.763 | 1.87 YR | 6.45/4.36 |
| 3 | blue sky | 18.41 | 19.08 | 37.43 | 50.784 | −1.546 | −21.219 | 3.2 PB | 4.92/5.32 |
| 4 | foliage | 10.40 | 12.98 | 7.25 | 42.731 | −16.474 | 22.362 | 6.47 GY | 4.15/4.20 |
| 5 | blue flower | 26.60 | 24.37 | 49.13 | 56.458 | 11.358 | −24.377 | 9.29 PB | 5.48/6.43 |
| 6 | bluish green | 32.24 | 42.74 | 48.47 | 71.375 | −31.482 | 2.019 | 1.81 BG | 6.98/6.12 |
| 7 | orange | 37.57 | 29.32 | 6.4 | 61.059 | 31.012 | 57.191 | 4.01 YR | 5.94/11.36 |
| 8 | purplish blue | 13.83 | 11.76 | 40.37 | 40.827 | 15.310 | −41.858 | 7.08 PB | 3.96/10.27 |
| 9 | moderate red | 29.31 | 19.21 | 14.89 | 50.936 | 45.793 | 15.116 | 2.38 R | 4.94/10.59 |
| 10 | purple | 8.92 | 6.51 | 15.91 | 30.671 | 23.685 | −22.054 | 4.84 P | 2.99/6.47 |
| 11 | yellow green | 34.22 | 43.66 | 12.13 | 72.002 | −27.279 | 58.064 | 4.8 GY | 7.04/8.99 |
| 12 | orange yellow | 47.59 | 43.12 | 9.13 | 71.637 | 15.207 | 65.914 | 9.11 YR | 7/10.71 |
| 13 | blue | 8.67 | 6.23 | 32.53 | 29.986 | 24.551 | −50.845 | 7.09 PB | 2.92/12.26 |
| 14 | green | 14.95 | 23.58 | 10.32 | 55.660 | −41.738 | 34.814 | 0.13 G | 5.4/8.82 |
| 15 | red | 20.75 | 11.81 | 5.63 | 40.905 | 52.685 | 25.598 | 4.8 R | 3.97/12.35 |
| 16 | yellow | 57.76 | 59.63 | 10.35 | 81.638 | −1.697 | 79.499 | 4.33 Y | 8.03/11.29 |
| 17 | magenta | 30.27 | 19.25 | 32.81 | 50.976 | 49.253 | −15.031 | 2.76 RP | 4.94/11.99 |
| 18 | cyan | 14.92 | 19.87 | 42.86 | 51.691 | −24.796 | −25.950 | 4.08 B | 5.01/8.29 |
| 19 | white (.05*) | 86.73 | 88.72 | 103.48 | 95.465 | −0.475 | 0.801 | N | 9.45/ |
| 20 | neutral 8 (.23*) | 57.26 | 58.39 | 68.75 | 80.953 | 0.033 | 0.168 | N | 7.96/ |
| 21 | neutral 6.5 (.44*) | 35.10 | 35.82 | 42.32 | 66.381 | −0.053 | −0.026 | N | 6.47/ |
| 22 | neutral 5 (.70*) | 19.90 | 20.31 | 24.00 | 52.181 | −0.031 | −0.036 | N | 5.06/ |
| 23 | neutral 3.5 (1.05*) | 9.05 | 9.26 | 11.09 | 36.479 | −0.264 | −0.428 | N | 3.55/ |
| 24 | black (1.50*) | 3.28 | 3.36 | 4.13 | 21.413 | −0.089 | −0.912 | N | 2.09/ |

TABLE 2
Colorimetric Data of the Optimal Set Generated by ONMF r = 7

| | CIEXYZ | | | CIE L*a*b* | | | Munsell Notation | |
|---|---|---|---|---|---|---|---|---|
| No. | X | Y | Z | L* | a* | b* | Hue Value/Chroma | |
| 1 | 16.97 | 16.76 | 42.62 | 47.958 | 2.976 | −32.124 | 4.99 PB | 4.65/7.88 |
| 2 | 14.63 | 10.54 | 27.90 | 38.790 | 29.055 | −29.171 | 4.07 P | 3.77/8.97 |
| 3 | 23.97 | 31.77 | 4.81 | 63.150 | −28.503 | 67.665 | 4.4 GY | 6.15/10.2 |
| 4 | 36.16 | 45.90 | 53.76 | 73.480 | −27.128 | 0.426 | 3 BG | 7.19/5.24 |
| 5 | 23.94 | 13.30 | 9.22 | 43.213 | 57.302 | 16.603 | 2.32 R | 4.19/13.15 |
| 6 | 59.38 | 55.17 | 15.66 | 79.140 | 12.966 | 62.049 | 9.4 YR | 7.77/9.96 |
| 7 | 30.01 | 30.56 | 35.58 | 62.132 | 0.212 | 0.632 | N | 6.04/ |

TABLE 3
Colorimetric Data of the Optimal Set Generated by ONMF r = 5

| | CIEXYZ | | | CIE L*a*b* | | | Munsell Notation | |
|---|---|---|---|---|---|---|---|---|
| No. | X | Y | Z | L* | a* | b* | Hue Value/Chroma | |
| 1 | 16.73 | 17.82 | 43.22 | 49.278 | −4.015 | −30.506 | 2.15 PB | 4.83/7.71 |
| 2 | 53.91 | 49.99 | 11.09 | 76.063 | 12.814 | 67.818 | 9.84 YR | 7.54/10.82 |
| 3 | 20.15 | 10.71 | 15.35 | 39.081 | 57.657 | −6.339 | 5.99 RP | 3.84/13.39 |
| 4 | 23.56 | 32.75 | 16.45 | 63.956 | −33.803 | 34.182 | 8.97 GY | 6.29/7.57 |
| 5 | 34.43 | 35.04 | 40.42 | 65.780 | 0.267 | 1.103 | N | 6.48/ |

TABLE 4
Colorimetric Data of the Optimal Set Generated by ONMF r = 6

| | CIEXYZ | | | CIE L*a*b* | | | Munsell Notation | |
|---|---|---|---|---|---|---|---|---|
| No. | X | Y | Z | L* | a* | b* | Hue Value/Chroma | |
| 1 | 65.71 | 66.50 | 21.39 | 85.253 | 1.135 | 61.414 | 3.06 Y | 8.49/8.92 |
| 2 | 21.57 | 22.33 | 49.03 | 54.375 | −1.478 | −27.867 | 3.37 PB | 5.33/7.08 |
| 3 | 21.57 | 30.77 | 17.83 | 62.315 | −35.729 | 28.527 | 0.42 G | 6.13/7.45 |
| 4 | 24.84 | 14.00 | 8.99 | 44.228 | 56.773 | 19.084 | 2.88 R | 4.34/13.27 |
| 5 | 14.79 | 10.93 | 27.32 | 39.464 | 27.117 | −27.149 | 4.27 P | 3.88/8.5 |
| 6 | 26.18 | 26.73 | 31.33 | 58.720 | −0.078 | 0.314 | N | 5.77/ |

TABLE 5
Colorimetric Data of the Optimal Set Generated by ONMF r = 8

| | CIEXYZ | | | CIE L*a*b* | | | Munsell Notation | |
|---|---|---|---|---|---|---|---|---|
| No. | X | Y | Z | L* | a* | b* | Hue Value/Chroma | |
| 1 | 50.12 | 45.05 | 8.33 | 72.927 | 16.487 | 70.683 | 8.94 YR | 7.21/11.58 |
| 2 | 14.13 | 9.81 | 27.05 | 37.501 | 31.547 | −30.130 | 4.48 P | 3.69/9.56 |
| 3 | 26.00 | 15.32 | 11.77 | 46.065 | 53.726 | 14.270 | 1.68 R | 4.52/12.51 |
| 4 | 12.63 | 10.79 | 38.32 | 39.220 | 14.493 | −42.230 | 6.81 PB | 3.85/10.41 |
| 5 | 27.38 | 34.55 | 2.13 | 65.399 | −24.025 | 87.864 | 2.43 GY | 6.37/12.42 |
| 6 | 26.30 | 36.14 | 43.51 | 66.627 | −33.687 | −0.915 | 3.37 BG | 6.57/6.72 |
| 7 | 92.36 | 94.37 | 110.77 | 97.779 | −0.280 | 0.395 | N | 9.68/ |
| 8 | 19.05 | 19.50 | 22.36 | 51.271 | −0.373 | 1.150 | N | 5.03/ |

TABLE 6
Colorimetric Data of the Optimal Set Generated by ONMF r = 9

| | CIEXYZ | | | CIE L*a*b* | | | Munsell Notation | |
|---|---|---|---|---|---|---|---|---|
| No. | X | Y | Z | L* | a* | b* | Hue Value/Chroma | |
| 1 | 12.71 | 10.42 | 38.29 | 38.579 | 17.777 | −43.298 | 7.33 PB | 3.75/10.6 |
| 2 | 14.04 | 9.83 | 27.19 | 37.532 | 30.869 | −30.282 | 4.17 P | 3.65/9.35 |
| 3 | 23.64 | 12.94 | 10.45 | 42.673 | 58.318 | 12.029 | 0.99 R | 4.14/13.3 |
| 4 | 23.92 | 34.00 | 43.29 | 64.962 | −36.531 | −3.541 | 4.36 BG | 6.33/7.36 |
| 5 | 39.30 | 35.61 | 28.16 | 66.217 | 14.274 | 17.737 | 1.88 YR | 6.45/4.35 |
| 6 | 27.62 | 34.80 | 2.03 | 65.595 | −23.936 | 89.032 | 2.36 GY | 6.39/12.55 |
| 7 | 50.33 | 45.07 | 8.32 | 72.940 | 16.993 | 70.751 | 8.82 YR | 7.14/11.53 |
| 8 | 91.72 | 93.73 | 110.04 | 97.522 | −0.304 | 0.384 | N | 9.65/ |
| 9 | 18.52 | 18.96 | 21.80 | 50.635 | −0.327 | 1.004 | N | 4.91/ |

TABLE 7
Performance Evaluation - Color Error ΔE_{ab}

| | | Adjustment Chart | |
|---|---|---|---|
| | | Macbeth | ONMF |
| | | ColorChecker | Optimal Set |
| Evaluation | Average ΔE_{ab} | 1.2039 | 1.2592 |
| Items | Maximum ΔE_{ab} | 4.2913 | 3.6247 |

What is claimed is:

1. A method for generating a color chart for imaging device calibration, comprising:
estimating a target set of reference colors that can be used for accurate reproduction of colors in an imaging system;
wherein said target set of reference colors is estimated from a source set of reference colors;
wherein said target set of reference colors contains fewer reference colors than said source set;
wherein said estimating comprises orthogonal non-negative matrix factorization (ONMF).

2. A method as recited in claim 1:
wherein said ONMF includes an orthogonality constraint such that a resultant factorized matrix corresponding to said target set of reference colors and an original data matrix of said source set of reference colors have approximately the same auto-correlation relationship; and
wherein, as a result of said orthogonality constraint, an auto-correlation matrix of W (rank r) equals an auto-correlation matrix of V (rank m) where r<m.

3. A method as recited in claim 1:
wherein said target set of reference colors comprises a set of spectral reflectances; and
wherein source set of reference colors comprises a set of twenty-four Macbeth ColorChecker reference colors.

4. A method as recited in claim 3:
wherein said target set of reference colors includes statistical characteristics of said Macbeth ColorChecker;
wherein said set of spectral reflectances has 2^{nd} order statistical characteristics similar to 2^{nd} order statistical characteristics of Macbeth ColorChecker;
wherein said set of spectral reflectances have an auto-correlation matrix similar to said Macbeth ColorChecker; and
wherein said set of spectral reflectances has principal components similar to said Macbeth ColorChecker.

5. A method as recited in claim 1:
wherein said target set of reference colors is generated using non-negativity and smoothness constraints which provide physically realizable colors; and
wherein said target set of reference colors is generated using orthogonality constraints which provide spectral reflectances with similar statistical properties to those of spectral reflectances in any source set of reference colors.

6. A method as recited in claim 1:
wherein said target set of reference colors comprises a set of five to nine reference colors; and
wherein said target set of reference colors is estimated from a set of twenty-four Macbeth ColorChecker reference colors.

7. A method as recited in claim 6, wherein said target set of reference colors provides substantially the same color calibration performance as said Macbeth ColorChecker.

8. A method as recited in claim 1:
wherein said target set of reference colors comprises a set of seven reference colors; and
wherein said target set of reference colors is estimated from a set of twenty-four Macbeth ColorChecker reference colors.

9. A method as recited in claim 8, wherein said target set of reference colors provides substantially the same color calibration performance as said Macbeth ColorChecker.

10. A method as recited in claim 1, wherein said imaging system comprises a component of a photographic imaging system, a graphics arts imaging system, an electronic publishing imaging system, a still or video camera system, a printer system, or a television system.

11. A color chart for color calibration of an imaging device, comprising:
a target set of reference colors estimated from a source set of reference colors using orthogonal non-negative matrix factorization (ONMF);
wherein said target set of reference colors contains fewer reference colors than said source set.

12. A color chart as recited in claim 11:
wherein said ONMF includes an orthogonality constraint such that a resultant factorized matrix corresponding to said target set of reference colors and an original data matrix of said source set of reference colors have approximately the same auto-correlation relationship; and
wherein, as a result of said orthogonality constraint, an auto-correlation matrix of W (rank r) equals an auto-correlation matrix of V (rank m) where r<m.

13. A color chart as recited in claim 11:
wherein said target set of reference colors comprises a set of spectral reflectances; and
wherein said source set of reference colors comprises a set of twenty-four Macbeth ColorChecker reference colors.

14. A color chart as recited in claim 13:
wherein target set of reference colors includes statistical characteristics of said Macbeth ColorChecker;
wherein said set of spectral reflectances has 2^{nd} order statistical characteristics similar to 2^{nd} order statistical characteristics of Macbeth ColorChecker;
wherein said set of spectral reflectances has an auto-correlation matrix similar to said Macbeth ColorChecker; and
wherein said set of spectral reflectances has principal components similar to said Macbeth ColorChecker.

15. A color chart as recited in claim 11:
wherein said target set of reference colors comprise physically realizable colors generated using non-negativity and smoothness constraints in said ONMF; and
wherein said target set of reference colors have spectral reflectances with similar statistical properties to those of spectral reflectances in said source set of reference colors.

16. A color chart as recited in claim 11:
wherein said target set of reference colors comprises a set of five to nine reference colors; and
wherein said source set of reference colors comprises a set of twenty-four Macbeth ColorChecker reference colors.

17. A color chart as recited in claim 16, wherein said target set of reference colors provides substantially the same color calibration performance as said Macbeth ColorChecker.

18. A color chart as recited in claim 11:
wherein said target set of reference colors comprises a set of seven reference colors; and
wherein said source set of reference colors comprises a set of twenty-four Macbeth ColorChecker reference colors.

19. A color chart as recited in claim 18, wherein said target set of reference colors provides substantially the same color calibration performance as said Macbeth ColorChecker.

20. A color chart as recited in claim 11, wherein said imaging system comprises a component of a photographic imaging system, a graphics arts imaging system, an electronic publishing imaging system, a still or video camera system, a printer system, or a television system.

21. A color chart for color calibration of an imaging device, comprising:
a target set of reference colors;
wherein said target set of reference colors is derived from the Macbeth ColorChecker set of reference colors using orthogonal non-negative matrix factorization (ONMF);
wherein said target set of reference colors contains fewer reference colors than said Macbeth ColorChecker set of reference colors;
wherein a factorized matrix corresponding to said target set of reference colors and an original data matrix of said Macbeth ColorChecker set of reference colors have approximately the same auto-correlation relationship;
wherein said target set of reference colors includes statistical characteristics of said Macbeth ColorChecker;
wherein said target set of reference colors comprises a set of spectral reflectances have 2^{nd} order statistical characteristics similar to 2^{nd} order statistical characteristics of said Macbeth ColorChecker;
wherein said set of spectral reflectances has principal components similar to principal components of said Macbeth ColorChecker;
wherein said set of spectral reflectances have an auto-correlation matrix similar to an auto-correlation matrix of said Macbeth ColorChecker; and
wherein said target set of reference colors provides substantially the same color calibration performance as said Macbeth ColorChecker.

22. A color chart as recited in claim 21, wherein said target set of reference colors comprise physically realizable colors generated using non-negativity and smoothness constraints in said ONMF.

23. A color chart as recited in claim 21, wherein said target set of reference colors comprises a set of five to nine reference colors.

24. A color chart as recited in claim 21, wherein said target set of reference colors comprises a set of seven reference colors.

25. A color chart as recited in claim 21, wherein said imaging system comprises a component of a photographic imaging system, a graphics arts imaging system, an electronic publishing imaging system, a still or video camera system, a printer system, or a television system.
